(19) United States
(12) Patent Application Publication
(10) Pub. No.: US 2004/0053540 A1
(43) Pub. Date: Mar. 18, 2004

(54) Electrical connector and method of assembling the same

(76) Inventors: Jerry Wu, Irvine, CA (US); Dennis B. Jones, Orange, CA (US)

Correspondence Address: WEI TE CHUNG, FOXCONN INTERNATIONAL, INC., 1650 MEMOREX DRIVE, SANTA CLARA, CA, 95050, US

(21) Appl. No.: 10/243,427

(22) Filed: Sep. 12, 2002

(51) Int. Cl. H01R 13/405

(52) U.S. Cl. 439/736

(57) ABSTRACT

A method of assembling an electrical connector (1) comprises the steps of: preparing a dielectric housing (2) defining a plurality of insertion slots therein; preparing a conductive contact strip (3a) comprising a plurality of contacts (3) and a carrier (3b) connecting with the contacts; preloading the contact strip into the housing; inserting a spacer (5) into the dielectric housing to position the contact strip, the spacer being inserted between an inner side surfaces (210) of the housing and mating portions (31) of the contacts; pulling the contact strip downwardly via a tool (4) gripping slots (35) defined in opposite sides of end portions (36) of the contacts; removing the spacer from the dielectric housing; severing the carrier and end portions of the contact strip; and bending mounting portions (34) of the contacts in an alternating manner.

### BACKGROUND OF THE INVENTION

1. Field of the Invention

The present invention relates to an electrical connector and a method of assembling the same. A copending application titled “ELECTRICAL CONNECTOR AND METHOD MANUFACTUREING SAME”, invented by Wei Hua Pan differently while with the same assignee as the instant application, discloses a related design.

2. Description of Related Art

Connectors generally have a large number of conductive contacts aligned in a dielectric housing thereof. Such connector must be designed to fulfill requirements of proper alignment, engagement and coplanarity of the contacts assembled in the housing. One way to assemble contacts of conventional connectors is to assemble the contacts from the top of the housing and pressed thereinto. However, achieving reliability of all the contacts assembled in the housing is difficult for connectors because the pressing force acting on the contacts is large and the contacts often change shape. Another way to retain the contacts in the housing is insert molding as disclosed in U.S. Pat. No. 6,102,748. The connector disclosed in U.S. Pat. No. 6,102,748 comprises a housing comprising a first housing member and a second housing member, two sets of contacts insert molded in opposite sides of the housing, and a shield covering the housing. The method of manufacturing the connector comprises the steps of: 1) insert molding a pair of contact carriers to opposite sides of the first housing member; 2) insert molding the first housing member having the two contact carriers to the second housing member; 3) severing carrier plates from the two contact carriers; and 4) assembling the shield to the housing. Such a method is reliable to retain the contacts in position. However, the manufacture cost is relatively high and the manufacture process is relatively complex.

Hence, an improved electrical connector is desired to overcome the disadvantages of the prior art.

### SUMMARY OF THE INVENTION

Accordingly, an object of the present invention is to provide a contact strip for an electrical connector which can be easily and reliably assembled in a housing of the electrical connector.

Another object of the present invention is providing a method of assembling an electrical connector at a low cost and with high efficiency.

To achieve the above objects, a method of assembling an electrical connector in accordance with the present invention comprises the steps of: 1) preparing a dielectric housing defining a plurality of insertion slots therein; 2) preparing a conductive contact strip comprising a plurality of contacts and a carrier connecting with the contacts, each contact comprising a mating portion adapted for electrically contacting a mating contact of a complementary connector, a head portion extending upwardly from the mating portion for being received in a corresponding insertion slot, a retention portion having a plurality of barbs for being secured in the housing, a mounting portion extending downwardly from the retention portion adapted for soldering to a printed circuit board, and an end portion extending downwardly from the mounting portion and defining a pair of slots in opposite respective sides thereof; 3) preloading the contact strip into the dielectric housing until the barbs of the retention portions of the contacts engage inner inclined surfaces of the insertion slots, the mounting portions of the contacts extending beyond the bottom of the housing; 4) inserting a spacer into the dielectric housing to position the contact strip, the spacer being inserted between and engaging with an inner side surface of the housing and the mating portions of the contact strip, the head portions of the contacts being rotatable beyond the top of the insertion slots; 5) pulling the contact strip downwardly via a tool, the pair of slots defined in opposite sides of the mounting portion of each contact being gripped by the tool to downwardly pull the contact strip; 6) removing the spacer from the dielectric housing; 7) severing the carrier and the end portions of the contacts; and 8) bending the mounting portions of the contacts in an alternating manner so that the mounting portions align in two rows.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of an electrical connector in accordance with the present invention;

FIG. 2 is a perspective view of a dielectric housing of the electrical connector of FIG. 1;

FIG. 3 is a cross sectional view of the dielectric housing taken along line 3-3 of FIG. 2;

FIG. 4 is a perspective view of a conductive contact for the electrical connector of FIG. 1;

FIG. 5 is a side elevational view of a contact strip having a plurality of contacts for the electrical connector of FIG. 1;

FIG. 6 is a front elevational view of the contact strip having a plurality of contacts for the electrical connector of FIG. 1;

FIG. 7 is a cross sectional view illustrating the contact strip preloaded in the dielectric housing;

FIG. 8 is another cross sectional view illustrating the contact strip preloaded in the dielectric housing;

FIG. 9 is a cross sectional view illustrating a spacer inserted between an inner side surface of the housing and the contact strip;

FIG. 10 is a cross sectional view illustrating how the contacts being pulled by a tool;

FIG. 11 is a cross sectional view illustrating the contacts being fully inserted into the housing, with a carrier of the contact strip being removed; and

FIG. 12 is a cross sectional view of the electrical connector taken along line 12-12 of FIG. 1.

### DETAILED DESCRIPTION OF THE INVENTION

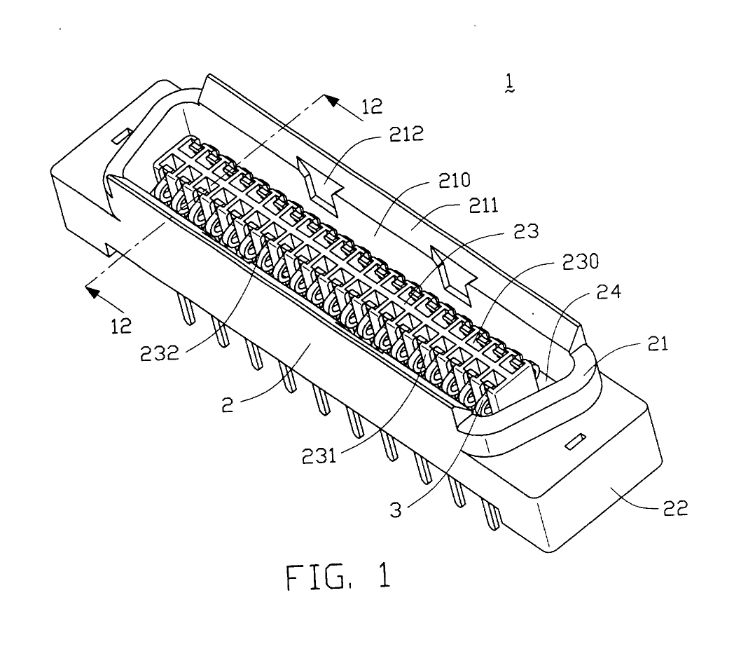

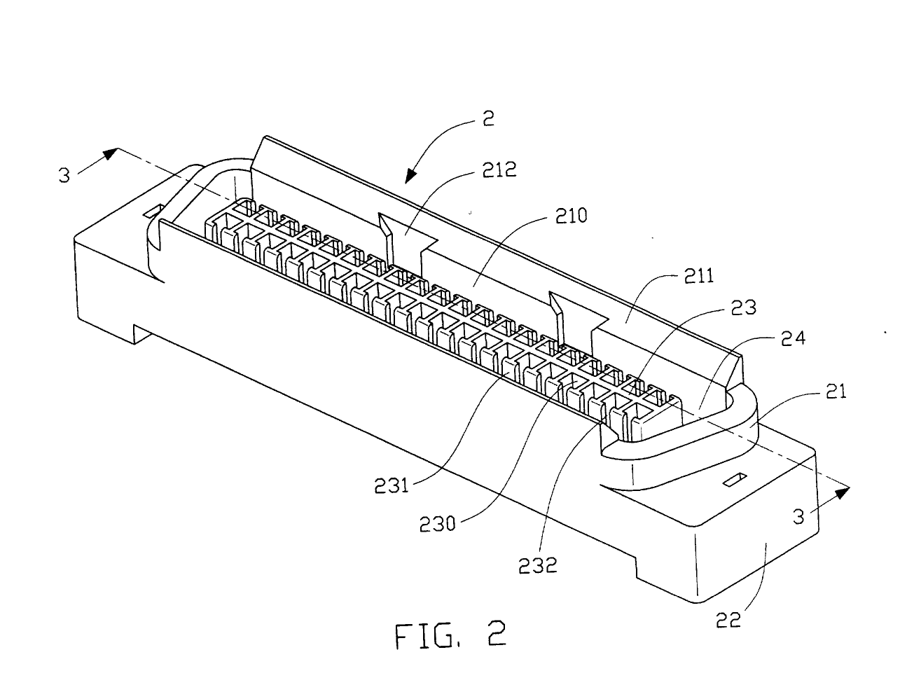

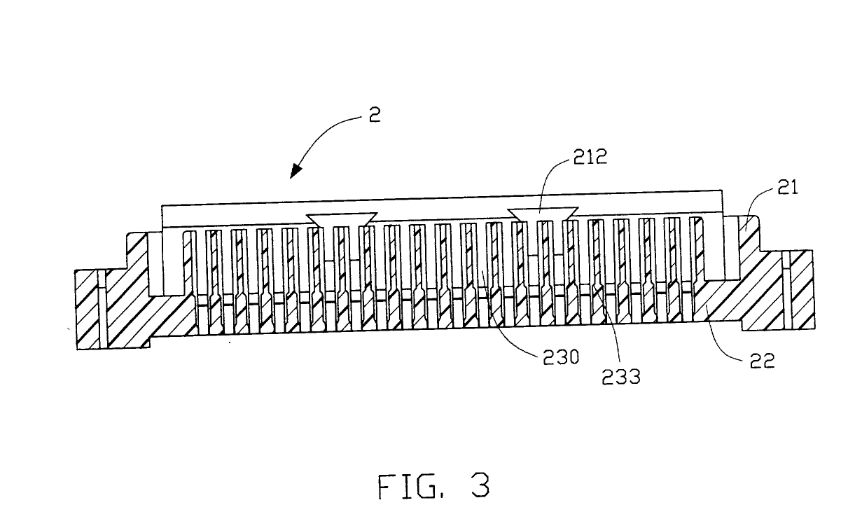

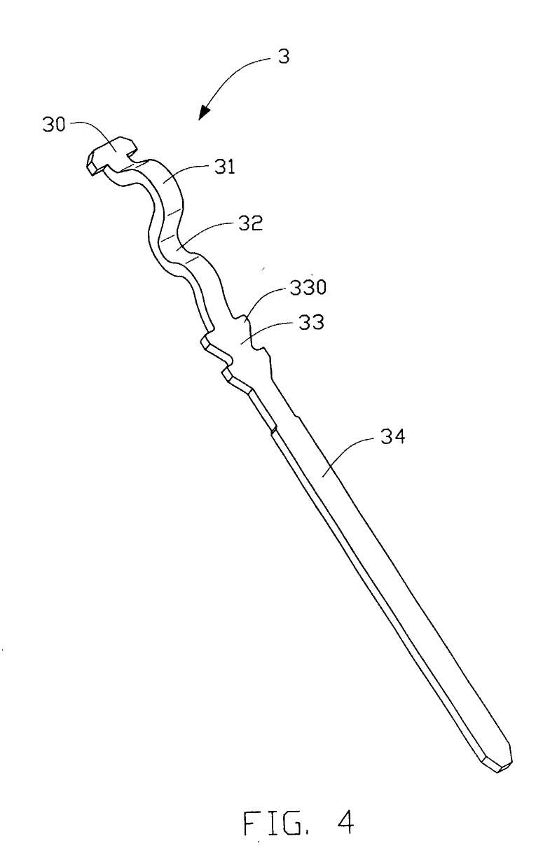

Referring to FIGS. 1-4, an electrical connector 1 in accordance with the present invention comprises a dielectric housing 2, and a plurality of conductive contacts 3 received in the housing 2.

The dielectric housing 2 is a one-piece structure unitarily molded of dielectric material such as plastic or the like. The housing 2 is elongated and comprises a rectangular base 22 and an upstanding mating frame 21. The mating frame 21 is of a known D-shaped configuration and defines a D-shaped cavity 24 for receiving a similarly shaped mating plug of a complementary connector (not shown). The mating frame 21 has a pair of laterally-spaced opposite inner side surfaces 210 and each inner side surface 210 defines a pair of swallow-tailed grooves 212 for engaging with corresponding portions of the complementary connector. A slant surface 211 is formed at an upper end of each inner side surface 210 for properly guiding the insertion of the complementary connector. A rectangular tongue 23 projects into the cavity 24 and defines two rows of insertion slots 230 on opposite respective sides thereof for receiving the contacts 3 therein. The insertion slots 230 are in communication with the cavity 24 defined in the mating frame 21 through a plurality of cutouts 232 and thus a plurality of ridges 231 is formed on opposite sides of the tongue 23.

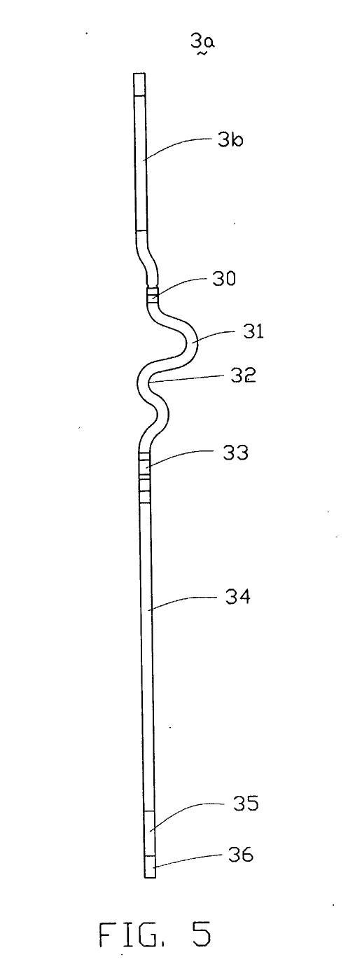

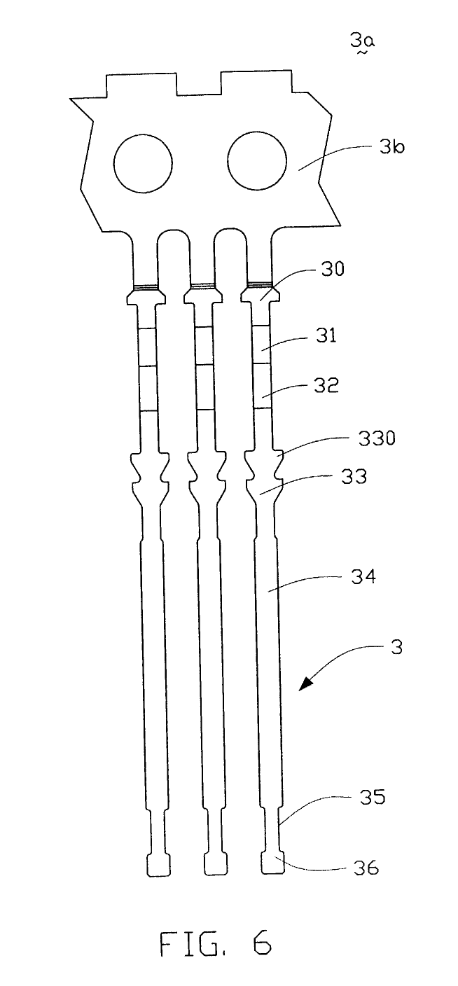

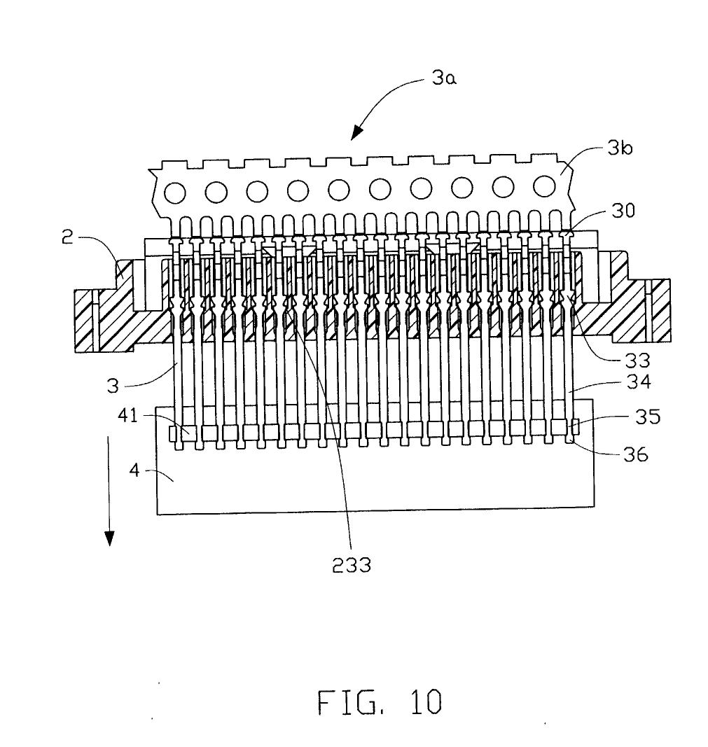

Referring to FIGS. 5 and 6, a contact strip 3a is stamped from a resilient metal sheet and includes a carrier 3b and a plurality of contacts 3. Each contact 3 includes a retention portion 33 with a plurality of barbs 330 formed on opposite sides thereof for engaging with a corresponding insertion slot 230 of the tongue 23. The contact 3 further includes a curved mating portion 31 for electrically contacting with a corresponding mating contact of the complementary connector, and a curved transition portion 32 connecting the mating portion 31 with the retention portion 33. A T-shaped head portion 30 extends upwardly from an upper end of the mating portion 31 for engaging with two corresponding ridges 231 formed on the tongue 23 of the housing 2. A mounting portion 34 extends downwardly from the retention portion 33 for solder connection to a printed circuit board (not shown). An end portion 36 extends downwardly from the mounting portion 34. A pair of slots 35 is defined in opposite sides of the end portion 36 for being conveniently gripped by a tool 4 (shown in FIG. 10). The carrier 3b integrally connects with upper ends of the T-shaped head portions 30.

In assembly, a pair of contact strips 3a will be respectively inserted into the two rows of insertion slots 230 of the dielectric housing 2 using the same method. Therefore, only the assembly process of one contact strip 3a to the dielectric housing 2 will be described in detail herein. The method comprises the steps of:

1) Preloading the contact strip 3a into the housing 2;

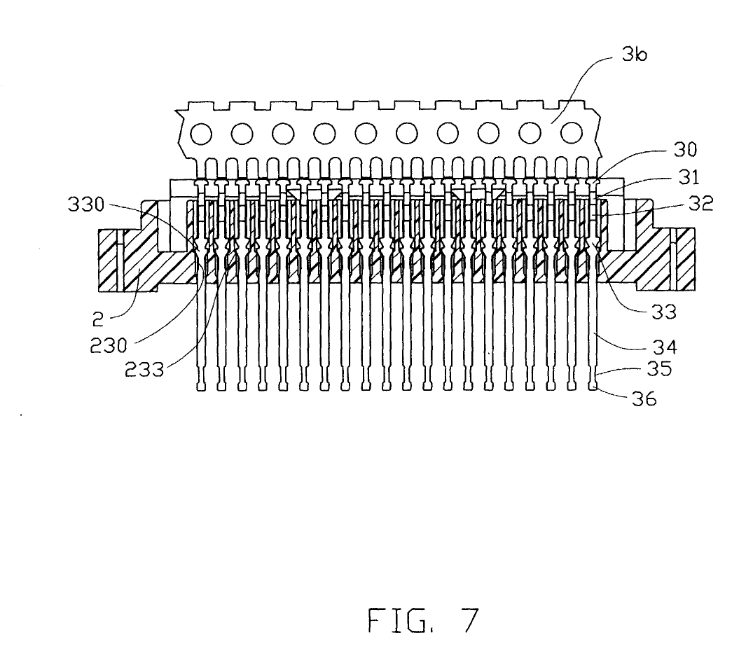

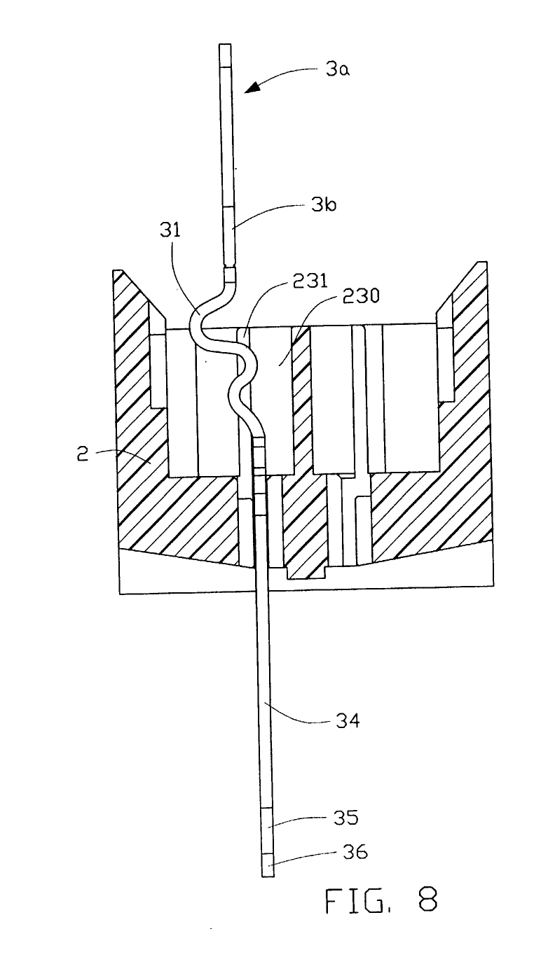

Referring to FIGS. 7 and 8, the contact strip 3a is top loaded into one row of slots 230 until the barbs 330 of the retention portions 33 of the contact strip 3a engage inner inclined surfaces 233 of the slots 230. The mounting portions 34 extend beyond the bottom of the housing 2.

2) Inserting a spacer 5 into the dielectric housing to position the contact strip;

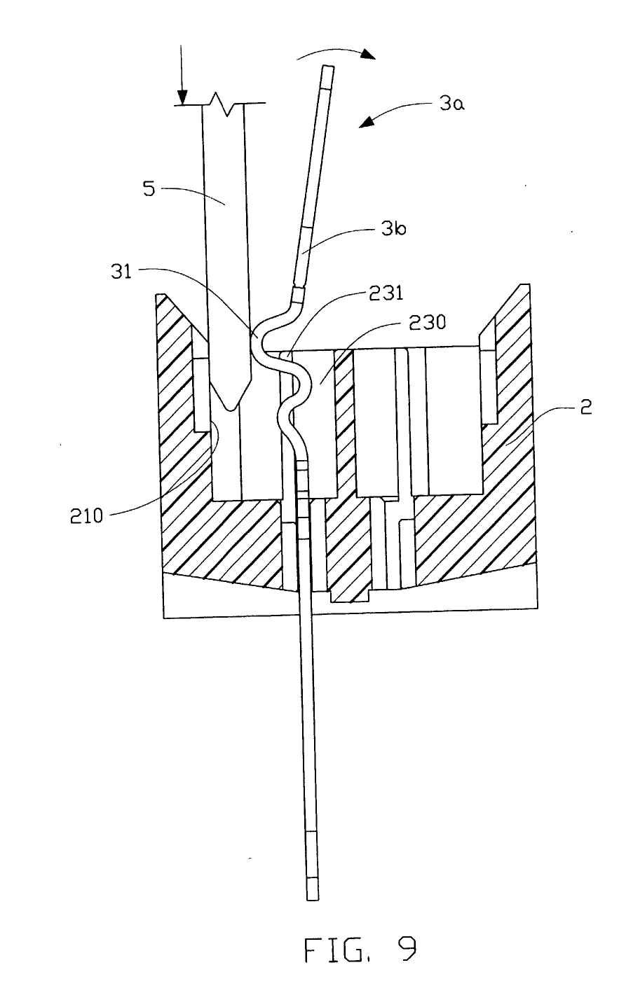

Referring to FIG. 9, a spacer 5 is inserted between and engages with an inner side surface 210 of the mating frame 21 and the mating portions 31 of the contact strip 3a. Therefore, the T-shaped head portions 30 are rotatable beyond the top of the insertion slots 230 defined in the tongue 23.

3) Pulling the contact strip 3a downwardly;

Referring to FIG. 10, the contact strip 3a is pulled downwardly by the tool 4. The tool 4 is a substantially rectangular board, and a plurality of protrusions 41 is formed on a side surface adjacent to an upper end thereof. The pair of slots 35 defined in the opposite sides of the end portion 36 of each contact 3 is gripped by corresponding two protrusions 41 of the tool 4 to downwardly pull the contact strip 3a. Thus, when a vertical force is applied to the tool 4, the contact strip 3a will be pulled downwardly to a predetermined position where the T-shaped head portion 30 of each contact is in a position shown in FIG. 1.

4) Removing the spacer 4 from the dielectric housing 2;

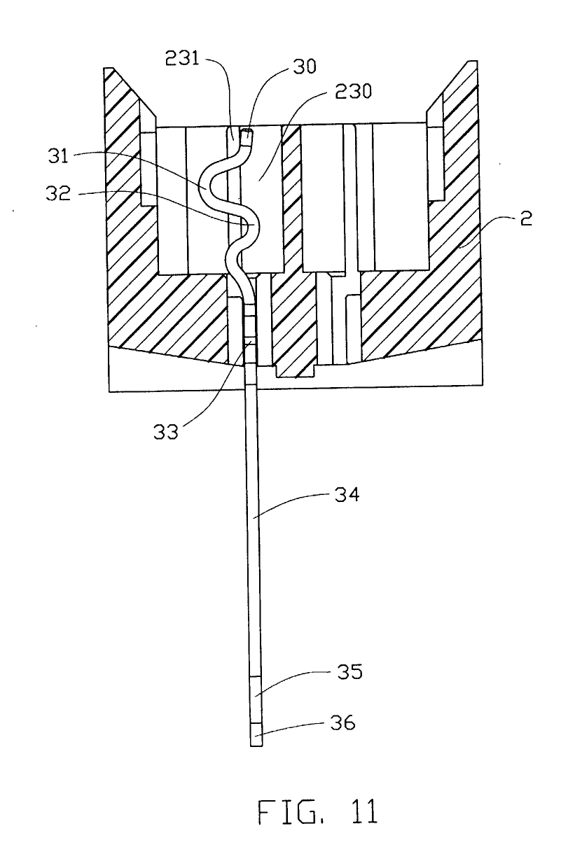

Now referring to FIG. 11 in conjunction with FIG. 9, the spacer 4 is removed from the dielectric housing 2.

5) Severing the carrier 3b and optionally the end portions 36 of the contact strip 3a;

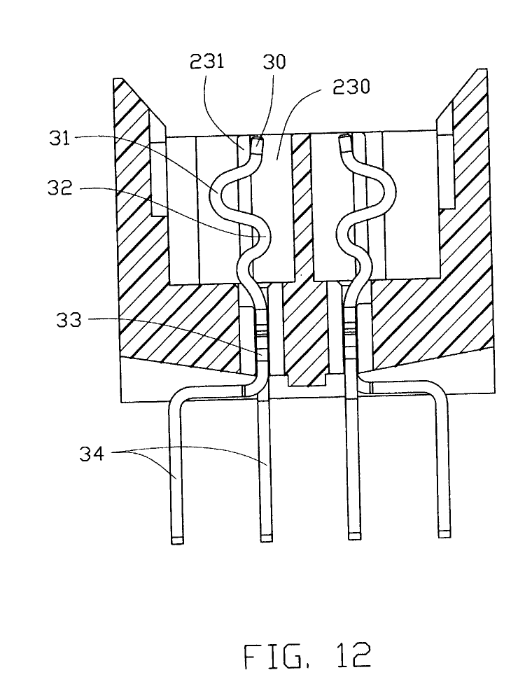

Referri ng to FIGS. 11 and 12 in conjunction with FIG. 10, the carrier 3b and the end portions 36 of the contacts 3 are severed from the contact strip 3a. Thus, the contacts 3 are individually separated.

6) Bending the mounting portions 34 of the contacts 3.

Referring to FIG. 12, the mounting portions 34 of the contacts 3 are bent in an alternating manner so that the mounting portions 34 align in two rows.

Repeating the steps described above, the other contact strip 3a is assembled into the other row of insertion slots 23 of the electrical connector 1 easily and reliably. In the whole assembling process, a top-loading force applied to the contacts 3 is relatively small. The forces acting on the contact strip 3a, including the force pulling the contacts 3 downwardly, are minimized. Therefore, the shape of the contact 3 changes minimally. In addition, the tool 4 efficiently and conveniently helps assembling the contacts 3 into the electrical connector 1 and the manufacture cost of the electrical connector 1 is reduced compared with that of an electrical connector produced by insert molding.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method of assembling an electrical connector, comprising the steps of:
preparing a dielectric housing defining a plurality of insertion slots therein;
preparing a conductive contact strip comprising a plurality of contacts and a carrier connecting with the contacts, each contact comprising a mating portion adapted for electrically contacting a mating contact of a complementary connector, a head portion extending upwardly from the mating portion for being received in a corresponding insertion slot, a retention portion having a plurality of barbs for being secured in the housing, a mounting portion extending downwardly from the retention portion adapted for soldering to a printed circuit board, and an end portion extending downwardly from the mounting portion and defining a pair of slots in opposite respective sides thereof;
preloading the contact strip into the dielectric housing until the barbs of the retention portions of the contacts engage inner inclined surfaces of the insertion slots, the mounting portions of the contacts extending beyond the bottom of the housing;
inserting a spacer into the dielectric housing to position the contact strip, the spacer being inserted between and engaging with an inner side surface of the housing and the mating portions of the contact strip, the head portions of the contacts being rotatable beyond the top of the insertion slots;
pulling the contact strip downwardly via a tool, the pair of slots defined in opposite sides of the mounting portion of each contact being gripped by the tool to downwardly pull the contact strip;
removing the spacer from the dielectric housing; and
severing the carrier and the end portions of the contacts.

2. The method of assembling an electrical connector as described in claim 1, wherein the step of preparing a dielectric housing comprises forming a rectangular base and an upstanding mating frame extending from the rectangular base and defining a cavity adapted for receiving the complementary connector.

3. The method of assembling an electrical connector as described in claim 2, wherein the step of preparing a dielectric housing comprises forming a pair of laterally-spaced opposite inner side surfaces in the mating frame and defining a pair of swallow-tailed grooves in each inner side surface adapted for engaging with corresponding portions of the complementary connector.

4. The method of assembling an electrical connector as described in claim 3, wherein the step of preparing a dielectric housing comprises forming a slant surface at an upper end of each inner side surface of the mating frame adapted for properly guiding the insertion of the complementary connector.

5. The method of assembling an electrical connector as described in claim 2, wherein the step of preparing a dielectric housing comprises forming a tongue projecting into the cavity, the insertion slots being defined in the tongue in communication with the cavity to form a plurality of ridges on the tongue.

6. The method of assembling an electrical connector as described in claim 5, wherein the step of preparing a conductive contact strip comprises forming the head portion of each contact in a “T” shape for engaging with corresponding ridges formed on the tongue.

7. The method of assembling an electrical connector as described in claim 1, wherein the step of preparing a conductive contact strip further comprises forming a curved transition portion on each contact, the transition portion connecting the mating portion with the retention portion.

8. The method of assembling an electrical connector as described in claim 1, further comprising bending the mounting portions of the contacts in an alternating manner.

9. A contact strip for an electrical connector, comprising:
a plurality of contacts each comprising a curved mating portion adapted for electrically contacting a mating contact of a complementary connector, a retention portion adapted for being secured in a dielectric housing of the electrical connector, a mounting portion extending downwardly from the retention portion adapted for soldering to a printed circuit board, and an end portion extending downwardly from the mounting portion and defining a pair of slots in opposite respective sides thereof for being gripped by a tool to completely assemble the contact to the dielectric housing of the electrical connector; and
a carrier integrally formed with the contacts.

10. The contact strip as described in claim 9, wherein each contact further comprises a T-shaped head portion formed at the top of the curved mating portion and connecting with the carrier.

11. The contact strip as described in claim 9, wherein each contact further comprises a curved transition portion connecting the mating portion and the retention portion.

12. The contact strip as described in claim 9, wherein the retention portion of each contact forms a plurality of barbs adapted for engaging with the dielectric housing of the electrical connector.

13. A method of assembling contacts into a housing of an electrical connector via a top loading procedure, comprising the steps of:
providing and insulative housing with a plurality of insertion slots between opposite first and second faces thereof;
providing a contact strip with a plurality of contacts connected to a carrier, each of said contacts including a tail portion, a mating portion located above the tail portion, a head portion located above the mating portion and connected to said carrier and adapted to be engaged with the housing for pre-loading before the connector is mated with a complementary connector,
providing the tail portions with gripping sections thereof, respectively;
inserting the contacts into the corresponding insertion slots from the first face toward the second face along an assembling direction, respectively, and then having the tail portions exposed outside of the second face; and
providing a gripping tool around the bottom face to grasp the exposed gripping sections to pull the contacts along the assembling direction until the contacts reach final positions along said assembling direction.

14. The method as described in claim 13, during the pulling step further comprising a step of providing a spacer to deflect the contacts until the contacts reach the final positions, and another step of removing said spacer to have the head portion abut against the housing around the first face in a preloaded manner.

15. The method as described in claim 13, further comprising a step of removing the carrier from the contacts.

16. The method as described in claim 13, further comprising a step of removing the gripping sections from the contacts, if necessary.

17. The method as described in claim 13, wherein said gripping sections are coplanar with the corresponding tail portions, respectively.

18. The method as described in claim 13, wherein each of said contacts includes a retention portion between the tail portion and the mating portion.

19. A method of assembling an electrical connector, comprising steps of:
providing an insulative housing with two opposite mating and mounting faces and a plurality of contact receiving passageways extending between said two faces;
providing a contact strip with a carrier and a plurality of juxtaposed contacts, each of said contacts including a mating portion with a head portion and a tail portion located at two opposite upper and lower sides thereof, the carrier connected to each of the contact along a direction from a mating face toward the mounting face;
via said carrier, simultaneously inserting the contacts into the corresponding passageways, respectively in said direction and exposing the tail portions outside the mounting face;
grasping the tail portions to pull said contacts along the same direction; wherein
portions of the tail portions perform gripping sections for pulling, and portions of the head portions perform preloading sections for reducing insertion force of a complementary connector mated therewith.

20. The method as described in claim 19, further comprising a step of removing said gripping sections, if necessary.

21. A contact strip stamped from sheet metal for use with an insulative housing of an electrical connector coupling to a complementary connector and mounted on a printed circuit board, comprising:
a carrier;
a plurality of juxtaposed contacts connected to the carrier, respectively, each of the contacts including a retention portion adapted to be secured to the housing, a tail portion located below the retention portion and adapted to be mounted to the printed circuit board, a mating portion located above the retention portion and adapted to be engaged with another terminals of said complementary connector, a head portion located above the mating portion and adapted to be engaged with the housing for preloading;
the carrier connected to each of the contact along a head-to-tail direction wherein
said tail portion includes a gripping section configured to be adapted to be engaged with a tool for pulling the contact in said head-to-tail direction during assembling the contact into the housing.

22. The contact strip as described in claim 21, where said gripping section is configured to be adapted to be optionally removed from the contact after assembled, without jeopardizing mounting function of the tail portion.

23. The contact strip as described in claim 21, wherein said gripping section is coplanar with the corresponding tail portion.
